(19) United States
(12) Patent Application Publication
(10) Pub. No.: US 2026/0178931 A1
(43) Pub. Date: Jun. 25, 2026

(54) TRAINING SYSTEM, TRAINING METHOD, AND COMPUTER PROGRAM FOR TRAINING

(71) Applicant: TOYOTA JIDOSHA KABUSHIKI KAISHA, Toyota-shi (JP)

(72) Inventors: Koichiro YAMAGUCHI, Tokyo-to (JP); Yasufumi KAWANO, Tokyo-to (JP)

(73) Assignee: TOYOTA JIDOSHA KABUSHIKI KAISHA, Toyota-shi (JP)

(21) Appl. No.: 19/328,743

(22) Filed: Sep. 15, 2025

(30) Foreign Application Priority Data
Dec. 23, 2024 (JP) 2024-226401

(51) Int. Cl. G06N 3/098

(52) U.S. Cl. CPC G06N 3/098

(57) ABSTRACT

Each local learning device included in a training system learns a subset of correction weighting factors for correcting part of a set of weighting factors of a basic model that is a base of a generation model, using a set of local training data, generates distribution data representing distribution of a feature of data included in the set of local training data, and transmits the learned subset and the distribution data to a server. The server generates a set of artificial training data, based on the distribution data received from each local learning device; the set of artificial training data reproduces distribution of a feature represented in the distribution data. With the set of artificial training data, the server trains a gate network for selecting a subset of correction weighting factors to be used.

### FIELD

The present invention relates to a training system, a training method, and a computer program for training a generation model.

### BACKGROUND

A proposed technique in construction of large language models (LLMs) improves the performance of a LLM, while limiting increase in the number of parameters of a model in the LLM, by a combination of a technique for combining multiple models, referred to as Mixture of experts (MoE), and a technique of parameter adjustment, referred to as Low-rank adaptation (LoRA) (see Syuntaro ITO and Daisuke KAWAHARA, “Construction of Knowledge-oriented Mixture of LoRA Experts,” The Association for Natural Language Processing, The 30th Annual Meeting Proceedings, pp. 3101-3106, March, 2024, [hereafter “Non-Patent Literature 1”]).

### SUMMARY

When weighting factors of individual LoRA portions are learned with local training data collected in different distributed areas, the local training data may not be taken outside from some distributed areas. In such a case, it is difficult to train a gate network of a MoE appropriately.

An object of the present invention is to provide a training system that can train a whole generation model appropriately without taking out a set of training data used for training part of the generation model from a learning device.

According to an embodiment, a training system including a server and a plurality of local learning devices is provided; the server is equipped with a basic model that is a base of a generation model generating a predetermined reply to inputted data by operation with a set of weighting factors. In the training system, each of the plurality of local learning devices is configured to learn a subset of correction weighting factors for correcting part of the set of weighting factors, using a set of local training data, generate distribution data representing distribution of a feature of individual pieces of local training data included in the set of local training data, and transmit the learned subset and the distribution data to the server. The server is configured to generate a set of artificial training data, based on the distribution data received from each of the plurality of local learning devices; the set of artificial training data reproduces distribution of a feature represented in the distribution data. The server trains a gate network in the generation model with the generated set of artificial training data; the gate network selects a subset to be used, depending on inputted data, from among the subsets received from the plurality of local learning devices.

In an embodiment, the server includes a memory configured to store the basic model and a set of standard training data, and store, for each of the plurality of local learning devices, the subset of correction weighting factors and the distribution data received from the local learning device; and a processor configured to: generate a subset of artificial training data for each of the plurality of local learning devices by selecting data included in the set of standard training data so that frequency distribution is the same as frequency distribution of individual items specifying a feature represented in the distribution data received from the local learning device, generate a set of the subsets of artificial training data generated for the plurality of local learning devices as the set of artificial training data, and train the gate network with the set of artificial training data.

In an embodiment, the processor of the server is further configured to learn the subset of correction weighting factors with a set of server training data collected by the server. The gate network is further configured to select a subset to be used, depending on inputted data, from among the subsets of correction weighting factors received from the plurality of local learning devices and the subset of correction weighting factors learned by the server. The processor of the server trains the gate network with the set of artificial training data and the set of server training data.

According to another embodiment, a training method is provided. The training method includes generating a set of artificial training data, based on distribution data received from each of a plurality of local learning devices; the set of artificial training data reproduces distribution of a feature represented in the distribution data; the distribution data represents distribution of a feature of individual pieces of local training data included in a set of local training data used for learning a subset of correction weighting factors for correcting part of a set of weighting factors in a basic model that is a base of a generation model generating a predetermined reply to inputted data by operation with the set of weighting factors. The training method further includes training a gate network in the generation model with the set of artificial training data; the gate network selects a subset to be used, depending on inputted data, from among the subsets of correction weighting factors received from the plurality of local learning devices.

According to still another embodiment, a non-transitory recording medium that stores a computer program for training is provided. The computer program includes instructions causing a computer to execute a process including generating a set of artificial training data, based on distribution data received from each of a plurality of local learning devices; the set of artificial training data reproduces distribution of a feature represented in the distribution data; the distribution data represents distribution of a feature of individual pieces of local training data included in a set of local training data used for learning a subset of correction weighting factors for correcting part of a set of weighting factors in a basic model that is a base of a generation model generating a predetermined reply to inputted data by operation with the set of weighting factors. The process further includes training a gate network in the generation model with the set of artificial training data; the gate network selects a subset to be used, depending on inputted data, from among the subsets of correction weighting factors received from the plurality of local learning devices.

The training system of the present disclosure has an advantageous effect of being able to train a whole generation model appropriately without taking out a set of training data used for training part of the generation model from a learning device.

### BRIEF DESCRIPTION OF DRAWINGS

FIG. 1 schematically illustrates the configuration of a training system.

FIG. 2 illustrates the hardware configuration of a local learning device and the functional blocks of a processor of the local learning device.

FIG. 3 illustrates the hardware configuration of a server and the functional blocks of a processor of the server.

FIG. 4 illustrates an overview of a training process.

FIG. 5 illustrates the sequence of the training process.

### DESCRIPTION OF EMBODIMENTS

A training system as well as a training method and a computer program for training executed by the training system will now be described with reference to the drawings. The training system trains a generation model. To achieve this, the training system includes a server equipped with a basic model that is a base of a generation model generating a predetermined reply to inputted data by operation with a set of weighting factors, and a plurality of local learning devices connected to the server via a communication network. Each local learning device learns a subset of correction weighting factors for correcting part of the set of weighting factors, using a set of local training data collected by the local learning device, and generates distribution data representing distribution of a feature of individual pieces of local training data included in the set of local training data. Each local learning device keeps the set of local training data therein, and transmits the subset of correction weighting factors and the distribution data to the server. The server generates a set of artificial training data, based on the distribution data received from each local learning device; the set of artificial training data reproduces distribution of a feature represented in the distribution data. With the set of artificial training data generated for each local learning device, the server trains a gate network for selecting a subset to be used, depending on data inputted into the basic model, from the subsets of correction weighting factors received from the local learning devices. The generation model is configured with the basic model, each subset of correction weighting factors, and the gate network. In other words, the basic model, each subset of correction weighting factors, and the gate network are parts of the generation model.

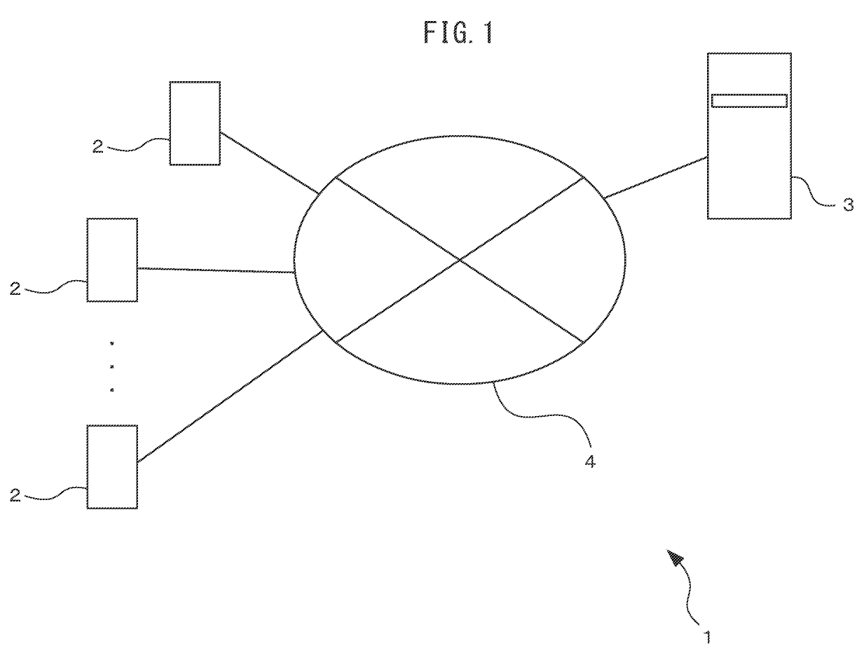

FIG. 1 schematically illustrates the configuration of the training system. In the present embodiment, the training system 1 includes a plurality of local learning devices 2 and a server 3. Each local learning device 2 is communicably connected to the server 3 via a communication network 4. The server 3 may be communicably connected to one or more communication terminals (not illustrated) via the communication network 4. The server 3 may receive input data for a generation model from a communication terminal via the communication network 4, and transmit reply data generated by the generation model in response to the input data to the communication terminal via the communication network 4.

The basic model is, for example, a LLM into which text data is inputted as input data and that generates a reply to the inputted text data as text data, or a vision language model (VLM) into which image data, together with text data, is inputted as input data. However, the basic model is not limited to a LLM or a VLM, and may be another generation model. In the present embodiment, the basic model has a structure with multiple stacked blocks each including an attention mechanism and a feed forward layer. When the basic model is a VLM, the basic model is further provided with a block into which images are inputted, separately from a block into which text data is inputted. In addition, the attention mechanism of a block included in the stacks operates as a cross attention layer into which data obtained by operation on an image and data obtained by operation on text data are inputted. Thus, sets of weighting factors constituting the attention mechanism and the feed forward layer included in each block are examples of a set of weighting factors of a basic model that determines operation on input data.

Each local learning device 2 is installed in a country or a region different from the country or region where the server 3 is installed. In the following description, a country and a region will be collectively referred to as a region. In addition, the local learning devices 2 are installed in different regions. Two or more local learning devices 2 may be installed in a single region. A set of local training data used for learning a subset of correction weighting factors in each local learning device 2 is collected in a region where the local learning device 2 is installed. Thus, transmission of a set of local training data to another local learning device 2 or the server 3 may be prohibited by a law or a rule of a region where the local learning device 2 is installed. For this reason, each local learning device 2 does not transmit a set of local training data itself to the server 3 or another local learning device 2.

The following describes details of each local learning device 2. Since each local learning device 2 may be assumed to have the same configuration and function in relation to a training process of the training system 1, the following describes a single local learning device 2.

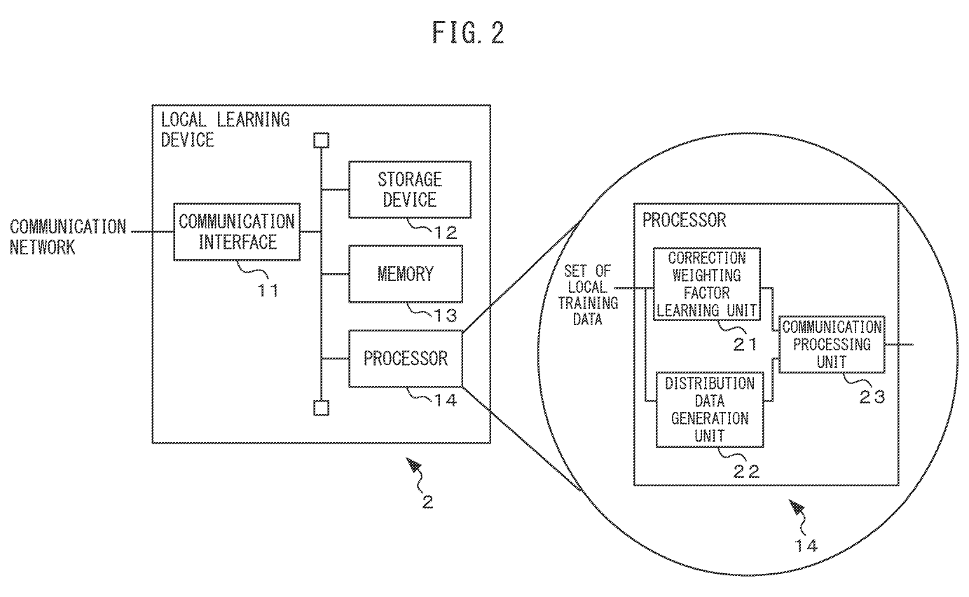

FIG. 2 illustrates the hardware configuration of the local learning device 2 and the functional blocks of a processor of the local learning device 2. The local learning device 2 includes a communication interface 11, a storage device 12, a memory 13, and a processor 14. The communication interface 11, the storage device 12, and the memory 13 are connected to the processor 14 via a signal line. The local learning device 2 may further include a user interface (not illustrated), such as a keyboard, a mouse, and a display.

The communication interface 11, which is an example of a communication unit, includes an interface circuit for connecting the local learning device 2 to the communication network 4. The communication interface 11 passes local training data received via the communication network 4 from another device (not illustrated) connected to the communication network 4 and installed in the same region as the local learning device 2, to the processor 14. The received local training data may include feature information representing a feature of the local training data. Further, the communication interface 11 passes a set of parameters specifying the basic model received from the server 3 via the communication network 4 to the processor 14. The communication interface 11 transmits a subset of correction weighting factors and distribution data received from the processor 14 to the server 3 via the communication interface 11.

The storage device 12, which is an example of a storage unit, includes, for example, a solid-state drive, a hard disk drive, or an optical medium and an access device therefor. The storage device 12 stores a set of parameters specifying the basic model, a subset of correction weighting factors, and position information indicating positions in the basic model to which this subset is applied. In addition, the storage device 12 stores a set of local training data.

The memory 13, which is another example of a storage unit, includes, for example, nonvolatile and volatile semiconductor memories. The memory 13 temporarily stores various types of data generated during execution of various processes executed in the local learning device 2 or used in these processes.

The processor 14 includes one or more central processing units (CPUs) and a peripheral circuit thereof. The processor 14 may further include another operating circuit, such as a logic unit, an arithmetic unit, or a graphics unit. The processor 14 executes processing of the local learning device 2 in the training process. Further, the processor 14 stores local training data received from another device and a set of parameters specifying the basic model received from the server 3 in the storage device 12.

As illustrated in FIG. 2, the processor 14 includes a correction weighting factor learning unit 21, a distribution data generation unit 22, and a communication processing unit 23. These units included in the processor 14 are, for example, functional modules implemented by a computer program executed by the processor 14, or may be dedicated operating circuits provided in processor 14.

The correction weighting factor learning unit 21 learns a subset of correction weighting factors with a set of local training data. A subset of correction weighting factors is used for correcting part of the set of weighting factors constituting the basic model. In the present embodiment, a subset of correction weighting factors may be used for correcting a weighting factor matrix used in a feed forward layer or a weighting factor matrix of Query, Key, or Value in an attention mechanism in one of the blocks included in the basic model. More specifically, a subset of correction weighting factors is defined as a set of values to be added to respective elements of these weighting factor matrices. A subset of correction weighting factors may be defined according to the LoRA technique. More specifically, a subset of correction weighting factors may be expressed as an approximation of a correction target weighting factor matrix by the product of two matrices having a lower rank than the weighting factor matrix. For example, when a correction target weighting factor matrix is expressed as a matrix with m rows and n columns (m and n are integers of 2 or more), a subset of correction weighting factors is expressed as the product of a matrix with m rows and k columns and a matrix with k rows and n columns (where k<m, n, e.g., k=1). The correction weighting factor learning unit 21 constructs a learning model in which individual correction weighting factors included in a subset of correction weighting factors are added to corresponding weighting factors of the basic model. In the learning model, individual weighting factors of the basic model are fixed, and only individual correction weighting factors included in the subset of correction weighting factors are targets for learning. The correction weighting factor learning unit 21 learns the subset of correction weighting factors by training the learning model with a set of local training data according to a predetermined training technique applied to the basic model.

The correction weighting factor learning unit 21 stores the learned subset of correction weighting factors and corresponding position information in the storage device 12.

The subsets of correction weighting factors learned in respective local learning devices 2 may correspond to the same subset or different subsets of weighting factors of the basic model. For example, a weighting factor matrix of an attention mechanism and a weighting factor matrix of a feed forward layer included in the same block of the basic model may be learned by two different local learning devices 2. Alternatively, weighting factor matrices of feed forward layers or attention mechanisms of different blocks of the basic model may be learned by different local learning devices 2.

The distribution data generation unit 22 generates distribution data representing distribution of a feature of individual pieces of local training data included in the set of local training data used for learning the subset of correction weighting factors.

For each item specifying a feature, the distribution data generation unit 22 determines the frequency of the item by referring to feature information of individual pieces of local training data or by analyzing individual pieces of local training data. For example, when the local training data is text data, the frequency is determined for each theme represented by the text data (e.g., cooking, current events, medical care, personal criticism, or technology in a specific field). The distribution data generation unit 22 then determines the frequencies of the respective themes as distribution data. When the local training data is images, the frequency is determined for each type of place represented in the images (e.g., park, urban area, suburb, expressway, or ordinary road) or each type of object represented in the images (e.g., human, vehicle, building, or specific facility). The distribution data generation unit 22 then determines the frequencies of the respective types of places or objects as distribution data.

The distribution data generation unit 22 stores the generated distribution data in the storage device 12.

The communication processing unit 23 transmits a subset of correction weighting factors and corresponding position information stored in the storage device 12 to the server 3 via the communication interface 11. Further, the communication processing unit 23 transmits that distribution data of a set of local training data used for learning a subset of correction weighting factors which is stored in the storage device 12, to the server 3 via the communication interface 11.

The following describes the server 3.

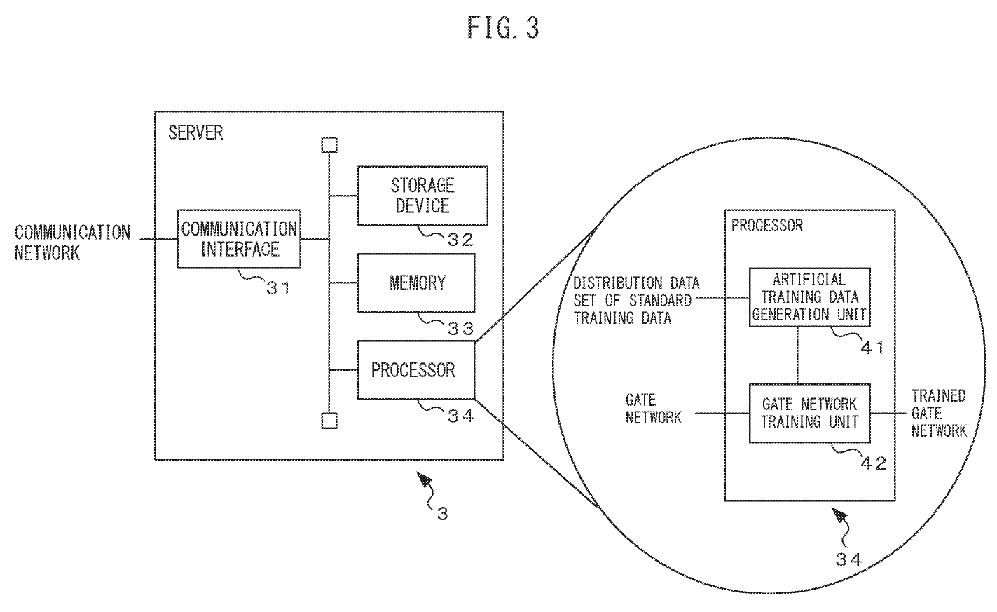

FIG. 3 illustrates the hardware configuration of the server 3 and the functional blocks of a processor of the server 3. The server 3 includes a communication interface 31, a storage device 32, a memory 33, and a processor 34. The communication interface 31, the storage device 32, and the memory 33 are connected to the processor 34 via a signal line. The server 3 may further include a user interface (not illustrated), such as a keyboard, a mouse, and a display.

The communication interface 31, which is an example of a communication unit, includes an interface circuit for connecting the server 3 to the communication network 4. The communication interface 31 passes a subset of correction weighting factors, corresponding position information, and distribution data of a set of local training data used for learning the subset of correction weighting factors that are received from each local learning device 2 via the communication network 4, to the processor 34. The communication interface 31 may transmit a set of parameters specifying the basic model received from the processor 34 to each local learning device 2 via the communication network 4.

The storage device 32, which is an example of the storage unit, includes, for example, a solid-state drive, a hard disk drive, or an optical medium and an access device therefor. The storage device 32 stores a set of parameters specifying the basic model. In addition, the storage device 32 stores a subset of correction weighting factors, corresponding position information, and distribution data that are received from each local learning device 2. In addition, the storage device 32 stores a set of parameters specifying a gate network. Further, the storage device 32 stores a set of standard training data used for generating a set of artificial training data used for training the gate network. To each piece of training data included in the set of standard training data is preset an optimal answer to the training data.

The memory 33, which is another example of the storage unit, includes, for example, nonvolatile and volatile semiconductor memories. The memory 33 temporarily stores various types of data generated during execution of various processes executed in the server 3 or used in these processes.

The processor 34 includes one or more central processing units (CPUs) and a peripheral circuit thereof. The processor 34 may further include another operating circuit, such as a logic unit, an arithmetic unit, or a graphics unit. The processor 34 executes processing of the server 3 in the training process. Further, the processor 34 stores a subset of correction weighting factors, corresponding position information, and distribution data that are received from each local learning device 2, in the storage device 32.

As illustrated in FIG. 3, the processor 34 includes an artificial training data generation unit 41 and a gate network training unit 42. These units included in the processor 34 are, for example, functional modules implemented by a computer program executed by the processor 34, or may be dedicated operating circuits provided in processor 14.

The artificial training data generation unit 41 generates a subset of artificial training data for each of the local learning devices 2, based on the distribution data received from the local learning device 2, so that frequency distribution is the same as frequency distribution of individual items specifying a feature represented in the distribution data. The artificial training data generation unit 41 then determines a set of the subsets of artificial training data generated for the respective local learning devices as the set of artificial training data.

When the local training data used for learning a subset of correction weighting factors in the local learning device 2 is text data as described above, the artificial training data generation unit 41 generates a subset of artificial training data so that the frequency distribution of each theme is the same as the frequency distribution represented in the distribution data. To achieve this, the artificial training data generation unit 41 generates a subset of artificial training data by selecting, for each theme, a number of pieces of data related to the theme from the set of standard training data, depending on the frequency distribution represented in the distribution data. The artificial training data generation unit 41 may generate one or more pieces of artificial training data included in the set of artificial training data by joining texts included in pieces of standard training data related to the same theme together or by substituting other sentences or words for some sentences or words in a piece of standard training data.

When the local training data is images, the artificial training data generation unit 41 generates a subset of artificial training data so that the frequency distribution of each type of place or object represented in the images is the same as the frequency distribution represented in the distribution data. To achieve this, the artificial training data generation unit 41 generates a subset of artificial training data by selecting, for each type of place or object represented in the images, a number of images representing a place or an object of the type from the set of standard training data, depending on the frequency distribution represented in the distribution data. The artificial training data generation unit 41 may use an image obtained by applying processing such as inversion, rotation, contrast adjustment, resolution conversion, noise reduction, or noise superposition to the standard training data as one or more pieces of artificial training data included in the set of artificial training data.

The artificial training data generation unit 41 stores the generated set of artificial training data in the storage device 32.

The gate network training unit 42 trains a gate network with the set of artificial training data. In the present embodiment, since the basic model is a LLM or a VLM and text data is inputted, the gate network is also configured so that text data is used as input data. For example, the gate network includes an encoder for natural language processing for converting inputted text data to values in continuous representation, such as BERT, a fully-connected layer that multiplies output of the encoder by a matrix for dimension adjustment, and an output layer that executes a softmax operation on output from the fully-connected layer. The result of the softmax operation is used as weighting factors for each subset of correction weighting factors. When the basic model is a VLM and data to be inputted into the gate network is images, one or more convolution layers may be provided instead of the encoder.

The gate network training unit 42 trains the gate network according to a predetermined supervised learning technique, such as backpropagation, so that one or more subsets of correction weighting factors capable of generating an answer corresponding to inputted artificial training data are selected from among the set of the subsets of correction weighting factors generated by the local learning devices 2. To this end, the gate network training unit 42 may train the gate network according to the technique described in Non-Patent Literature 1 above.

When training of the gate network is finished, the generation model configured with the basic model, each subset of correction weighting factors, and the gate network becomes usable. Upon input of data into the generation model, the gate network calculates weighting factors for each subset of correction weighting factors. Each subset of correction weighting factors is weighted by corresponding weighting factors obtained by the gate network, and is added to individual weighting factors at corresponding positions in the basic model, so that the basic model is corrected. An answer is generated by data being inputted into the corrected basic model.

The gate network may be configured and trained so that only a single subset of correction weighting factors is selected for inputted data. In this case, the output layer of the gate network may execute a sigmoid operation to calculate the degree of appropriateness of use for each subset of correction weighting factors. In this case, only a subset of correction weighting factors whose degree of appropriateness has a maximum value is used for correcting the basic model.

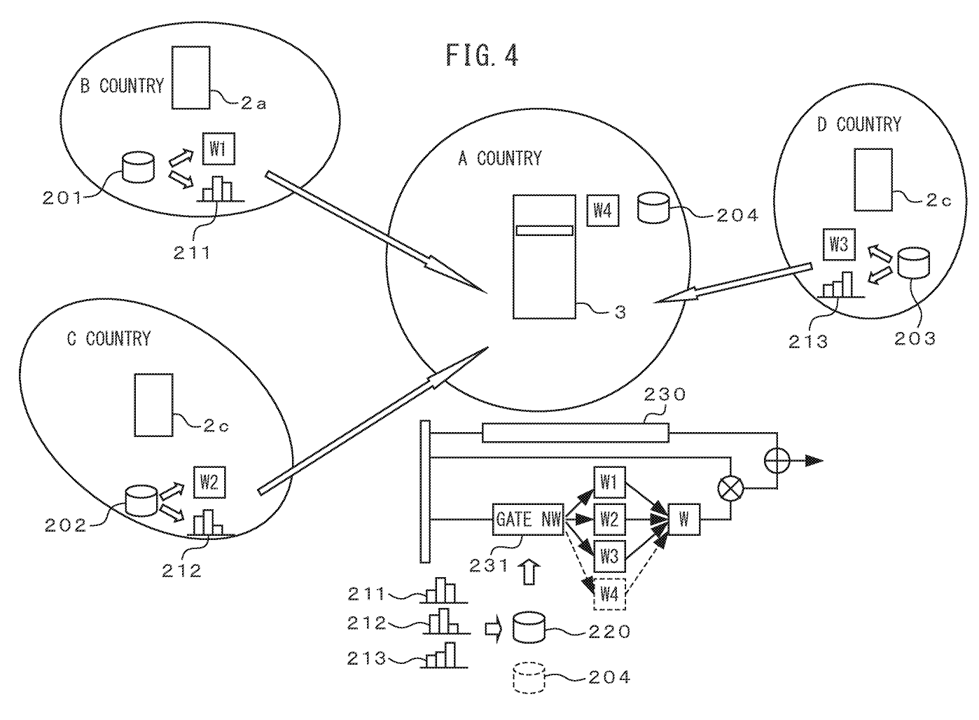

FIG. 4 illustrates the training process of the present embodiment. In the example illustrated in FIG. 4, the server 3 is installed in A country; three local learning devices 2a, 2b, and 2c are installed in B, C, and D countries, respectively. The local learning device 2a learns a subset W1 of correction weighting factors with a set 201 of local training data collected in B country where the device is installed, and generates distribution data 211 of the set 201 of local training data. Similarly, the local learning device 2b learns a subset W2 of correction weighting factors with a set 202 of local training data collected in C country where the device is installed, and generates distribution data 212 of the set 202 of local training data. In addition, the local learning device 2c learns a subset W3 of correction weighting factors with a set 203 of local training data collected in D country where the device is installed, and generates distribution data 213 of the set 203 of local training data. The server 3 receives the subsets W1, W2, and W3 of correction weighting factors, position information, and the distribution data 211, 212, and 213 from the local learning devices 2a to 2c, respectively. The server 3 generates a set 220 of artificial training data, based on the distribution data 211, 212, and 213. With the set 220 of artificial training data, the server 3 trains a gate network 231 for selecting a subset W to be used for a correction target layer 230 in a standard network from the subsets W1, W2, and W3 of correction weighting factors, based on inputted data. The server 3 may learn a subset W4 of correction weighting factors with a set 204 of local training data collected in A country where the server is installed (server training data), and train the gate network 231 with the set 204 of local training data collected in A country as well as the set 220 of artificial training data. In this case, the gate network 231 is trained to select one of the subsets W1 to W4 of correction weighting factors, depending on inputted data. The set 204 of local training data collected in A country need not be taken outside, and thus can be used as data for training the gate network without being processed, together with a subset of correction weighting factors. In this case, the processor 34 of the server 3 is further configured to achieve a function similar to that of the correction weighting factor learning unit 21 included in each local learning device 2. The set 204 of local training data collected by the server 3 may include data that is obtained in a region other than A country but that can be taken out to A country.

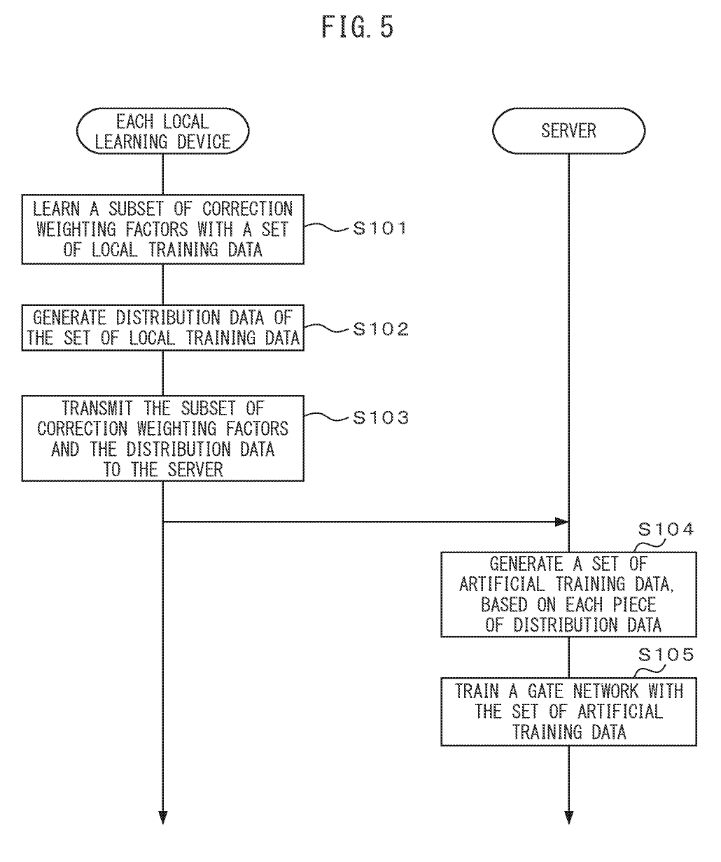

FIG. 5 illustrates the sequence of the training process of the present embodiment.

Each local learning device 2 learns a subset of correction weighting factors with a set of local training data (step S101). Each local learning device 2 further generates distribution data of the set of local training data used for learning the subset of correction weighting factors (step S102). Each local learning device 2 transmits the subset of correction weighting factors and the distribution data to the server 3 via the communication network 4 (step S103).

The server 3 generates a set of artificial training data, based on the distribution data received from each local learning device 2 (step S104). The server 3 trains a gate network with the set of artificial training data (step S105). Each local learning device 2 and the server 3 then terminate the training process.

As has been described above, the server of the training system generates a set of artificial training data, based on distribution data from each local learning device representing distribution of a feature of individual pieces of local training data included in a set of local training data used for learning a subset of correction weighting factors, and trains a gate network with the generated set of artificial training data. Thus, in the training system, it is unnecessary to transmit the set of local training data itself from the local learning device to the server. The training system can therefore train a whole generation model appropriately without taking out a set of training data used for training part of the generation model from a learning device.

The computer program for achieving the training process of the above-described embodiment or modified example may be provided, for example, in a form recorded on a computer-readable portable storage medium as a computer program product.

As described above, those skilled in the art may make various modifications according to embodiments within the scope of the present invention.

What is claimed is:

1. A training system comprising a server and a plurality of local learning devices, the server being equipped with a basic model that is a base of a generation model generating a predetermined reply to inputted data by operation with a set of weighting factors, wherein
each of the plurality of local learning devices is configured to:
learn a subset of correction weighting factors for correcting part of the set of weighting factors, using a set of local training data,
generate distribution data representing distribution of a feature of individual pieces of local training data included in the set of local training data, and
transmit the learned subset and the distribution data to the server, wherein
the server is configured to:
generate a set of artificial training data, based on the distribution data received from each of the plurality of local learning devices, the set of artificial training data reproducing distribution of a feature represented in the distribution data, and
train a gate network in the generation model with the set of artificial training data, the gate network selecting a subset to be used, depending on inputted data, from among the subsets received from the plurality of local learning devices.

2. The training system according to claim 1, wherein the server comprises:
a memory configured to store the basic model and a set of standard training data, and store, for each of the plurality of local learning devices, the subset of correction weighting factors and the distribution data received from the local learning device; and
a processor configured to:
generate a subset of artificial training data for each of the plurality of local learning devices by selecting data included in the set of standard training data so that frequency distribution is the same as frequency distribution of individual items specifying a feature represented in the distribution data received from the local learning device,
generate a set of the subsets of artificial training data generated for the plurality of local learning devices as the set of artificial training data, and
train the gate network with the set of artificial training data.

3. The training system according to claim 2, wherein the processer of the server is further configured to learn the subset of correction weighting factors with a set of server training data collected by the server,
the gate network is further configured to select a subset to be used, depending on inputted data, from the subsets received from among the plurality of local learning devices and the subset learned by the server, and
the processer of the server trains the gate network with the set of artificial training data and the set of server training data.

4. A training method comprising:
generating a set of artificial training data, based on distribution data received from each of a plurality of local learning devices, the set of artificial training data reproducing distribution of a feature represented in the distribution data, the distribution data representing distribution of a feature of individual pieces of local training data included in a set of local training data used for learning a subset of correction weighting factors for correcting part of a set of weighting factors in a basic model that is a base of a generation model generating a predetermined reply to inputted data by operation with the set of weighting factors; and
training a gate network in the generation model with the set of artificial training data, the gate network selecting a subset to be used, depending on inputted data, from among the subsets received from the plurality of local learning devices.

5. A non-transitory recording medium that stores a computer program for training, the computer program causing a computer to execute a process comprising:
generating a set of artificial training data, based on distribution data received from each of a plurality of local learning devices, the set of artificial training data reproducing distribution of a feature represented in the distribution data, the distribution data representing distribution of a feature of individual pieces of local training data included in a set of local training data used for learning a subset of correction weighting factors for correcting part of a set of weighting factors in a basic model that is a base of a generation model generating a predetermined reply to inputted data by operation with the set of weighting factors; and
training a gate network in the generation model with the set of artificial training data, the gate network selecting a subset to be used, depending on inputted data, from among the subsets received from the plurality of local learning devices.
